(19) United States
(12) Patent Application Publication
(10) Pub. No.: US 2019/0286343 A1
(43) Pub. Date: Sep. 19, 2019

(54) MAPPING TABLE MANAGEMENT METHOD FOR SOLID STATE STORAGE DEVICE

(71) Applicants: Lite-On Electronics (Guangzhou) Limited, Guangzhou (CN); Lite-On Technology Corporation, Taipei (TW)

(72) Inventors: Sen-Ming Chuang, Taipei City (TW); Ming-Chun Tsai, Taipei City (TW); Che-Wei Su, Taipei City (TW)

(21) Appl. No.: 15/976,917

(22) Filed: May 11, 2018

(30) Foreign Application Priority Data
Mar. 15, 2018 (CN) 201810214350.6

(51) Int. Cl. G06F 3/06; G06F 12/1009

(52) U.S. Cl. CPC G06F 3/0619; G06F 12/1009; G06F 3/0658; G06F 2212/20; G06F 3/068; G06F 2212/1032; G06F 2212/214; G06F 3/0659

(57) ABSTRACT

A mapping table management method for a solid state storage device is provided. The solid state storage device includes a control circuit, a dynamic random access memory and a non-volatile memory. The mapping table management method includes the following steps. When the control circuit receives a write command, the control circuit stores a write data into the non-volatile memory and updates a mapping table in the dynamic random access memory. If the control circuit receives a power-off command, the control circuit stores an entire of the mapping table from the dynamic random access memory to the non-volatile memory. If the control circuit judges that an update condition is satisfied, the control circuit stores a portion of the mapping table from the dynamic random access memory to the non-volatile memory.

This application claims the benefit of People's Republic of China Patent Application No. 201810214350.6, filed Mar. 15, 2018, the subject matter of which is incorporated herein by reference.

### FIELD OF THE INVENTION

The present invention relates to a processing method for a solid state storage device, and more particularly to a mapping table management method for a solid state storage device.

### BACKGROUND OF THE INVENTION

As is well known, solid state storage devices such as SD cards or solid state drives (SSD) are widely used in various electronic devices. Generally, a solid state storage device comprises a non-volatile memory. After data are written to the non-volatile memory, if no electric power is supplied to the solid state storage device, the data are still retained in the non-volatile memory.

FIG. 1 is a schematic functional block diagram illustrating the architecture of a conventional solid state storage device. As shown in FIG. 1, the solid state storage device 100 comprises a control circuit 10, a dynamic random access memory (DRAM) 30 and a non-volatile memory 20. The control circuit 10 is connected with the DRAM 30 and the non-volatile memory 20. The control circuit 10 is in communication with a host 150 through an external bus 110. For example, the external bus 110 is a USB bus, an SATA bus, a PCIe bus, an M.2 bus, a U.2 bus, or the like.

Generally, the host 150 defines the data addresses of the solid state storage device 100 through logical block addresses (LBAs). Moreover, the non-volatile memory 20 defines the data addresses of the non-volatile memory 120 through physical allocation addresses (PAAs).

Moreover, a mapping table 32 about the relationships between the LBA addresses and the PAA addresses is stored in the DRAM 30 of the solid state storage device 100. The mapping table 32 is also referred to a logical-to-physical address mapping table. The operating principles of the mapping table 32 will be described as follows.

When the host 150 intends to write a data into the solid state storage device 100, the host 150 issues a write command to the solid state storage device 100. The write command contains the LBA address and the write data. Then, the control circuit 10 records the relationship between the LBA addresses and the PAA addresses in the mapping table 32 stored in the DRAM 30. In addition, the write data is stored into the storage space of the PAA address of the non-volatile memory 20.

When the host 150 intends to read a data from the solid state storage device 100, the host 150 issues a read command. The read command contains the LBA address. After the control circuit 10 receives the read command, the control circuit 10 searches the PAA address from the mapping table 32 according to the LBA address. Then, the control circuit 10 acquires the read data from the storage space of the PAA address of the non-volatile memory 20 and transmits the read data to the host 150.

As mentioned above, the control circuit 10 has to record the mapping table 32 during the process of writing the data into the solid state storage device 100. Consequently, the control circuit 10 can handle all write data in the non-volatile memory 20 and effectively manage the data.

The mapping table 32 is stored in the DRAM 30. If no electric power is supplied to the solid state storage device 100, the data stored in the DRAM 30 is lost. Consequently, when the solid state storage device 100 receives a power-off command, the control circuit 10 has to store the mapping table 32 into the non-volatile memory 20. Then, the solid state storage device 100 can be powered off.

When the solid state storage device 100 is powered on again, the control circuit 10 has to load the mapping table 32 from the non-volatile memory 20 to the DRAM 30. Consequently, the solid state storage device 100 is in a normal working state.

As mentioned above, the relationships between the LBA addresses and the PAA addresses are record and update in the mapping table 32 stored in the DRAM 30 when the solid state storage device 100 is in the normal working state.

When the solid state storage device 100 is in the normal working state to access many data, if the electric power supplied to the solid state storage device 100 is suddenly interrupted, the data in the mapping table 32 stored in the DRAM 30 are all deleted.

When the solid state storage device 100 is powered on again, the control circuit 10 is only able to load the old mapping table 32 from the non-volatile memory 20 to the DRAM 30. Then, the control circuit 10 has to search all storage spaces of the non-volatile memory 20 to modify and rebuild the mapping table 32.

After the control circuit 10 searches all storage spaces of the non-volatile memory 20 and rebuilds the mapping table 32, the solid state storage device 100 can be normally operated. However, the process of rebuilding the mapping table 32 is time-consuming.

### SUMMARY OF THE INVENTION

An embodiment of the present invention provides a mapping table management method for a solid state storage device. The solid state storage device includes a control circuit, a dynamic random access memory and a non-volatile memory. The mapping table management method includes the following steps. When the control circuit receives a write command, the control circuit stores a write data into the non-volatile memory and updates a mapping table in the dynamic random access memory. If the control circuit receives a power-off command, the control circuit stores an entire of the mapping table from the dynamic random access memory to the non-volatile memory. If the control circuit judges that an update condition is satisfied, the control circuit stores a portion of the mapping table from the dynamic random access memory to the non-volatile memory.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating the architecture of a conventional solid state drive;

FIG. 2 is a flowchart illustrating a mapping table management method for a solid state storage device according to a first embodiment of the present invention; and

FIG. 3 is a flowchart illustrating a mapping table management method for a solid state storage device according to a second embodiment of the present invention.

### DETAILED DESCRIPTION OF PREFERRED EMBODIMENTS

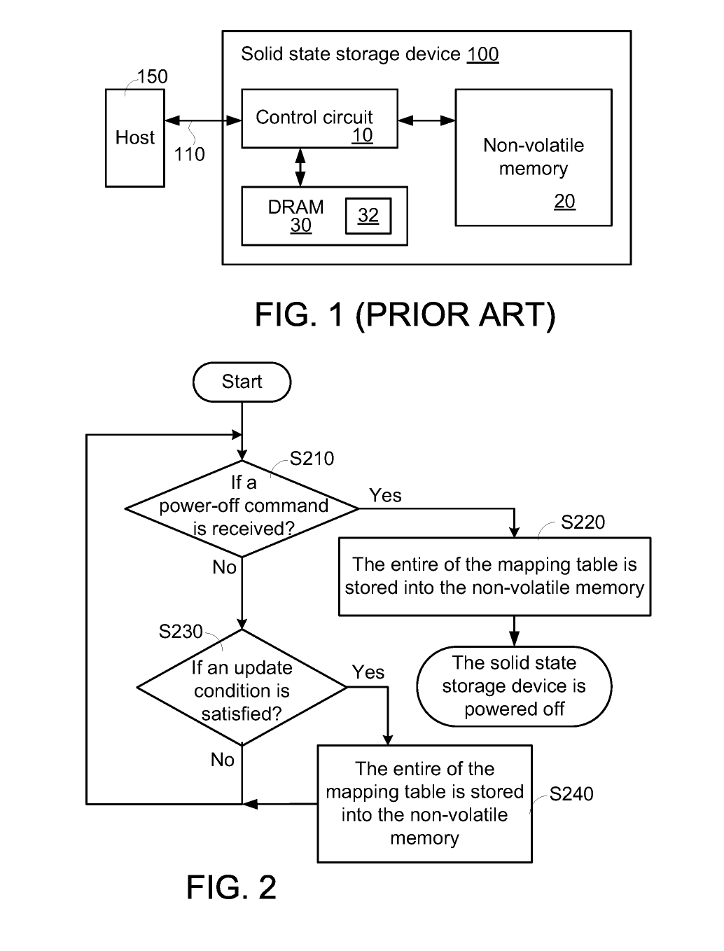

FIG. 2 is a flowchart illustrating a mapping table management method for a solid state storage device according to a first embodiment of the present invention. The mapping table management method is applied to a solid state storage device. The architecture of the solid state storage device is similar to that of FIG. 1, and is not redundantly described herein.

When the solid state storage device 100 is in the normal working state and the control circuit 10 receives a write command from the host 150, the control circuit 10 stores the write data into the non-volatile memory 20. In addition, the control circuit 10 updates the mapping table 32 stored in the DRAM 30.

When the solid state storage device 100 is in the normal working state and the solid state storage device 100 does not receive a power-off command (Step S210), the control circuit 10 judges whether an update condition is satisfied (Step S230). If the control circuit 10 judges that the update condition is satisfied, the control circuit 10 stores the entire of the mapping table 32 from the DRAM 30 to the non-volatile memory 20 (Step S240). Whereas, if the control circuit 10 judges that the update condition is not satisfied, the step S210 is repeatedly done.

In an embodiment, the update condition is determined according to a predetermined data amount (e.g., 10 Mbyte). The control circuit 10 continuously calculates the total data amount of the write data that are stored in the non-volatile memory 20. If the total data amount of the write data reaches an integral multiple of the predetermined data amount, the update condition is satisfied. Meanwhile, the control circuit 10 stores the entire of the mapping table 32 from the DRAM 30 to the non-volatile memory 20.

That is, whenever the total data amount of the write data reaches the integral multiple of the predetermined data amount, e.g., 10 Mbyte, 20 Mbyte, 30 Mbyte, and so on, the update condition is satisfied. Meanwhile, the control circuit 10 stores the entire of the mapping table 32 from the DRAM 30 to the non-volatile memory 20. Whereas, if the total data amount of the write data does not reach the integral multiple of the predetermined data amount, the control circuit 10 continuously calculates the total data amount of the write data. Meanwhile, the newly updated mapping table 32 stored in the DRAM 30 has not stored into the non-volatile memory 20.

If the solid state storage device 100 receives the power-off command in the step S210, the control circuit 10 stores the entire of the mapping table 32 from the DRAM 30 to the non-volatile memory 20 (Step S220). Then, the solid state storage device 100 is powered off.

When the solid state storage device 100 is in the normal working state, the mapping table 32 in the DRAM 30 is continuously updated. As mentioned above, the updated mapping table 32 in the DRAM 30 is stored into the non-volatile memory 20 when the solid state storage device 100 is in the normal working state. Under this circumstance, if the electric power supplied to the solid state storage device 100 is abnormally interrupted, the mapping table stored in the non-volatile memory 20 has been updated and has less different with the latest mapping table 32 in the DRAM 30.

When the solid state storage device 100 is powered on again, the control circuit 10 loads the updated version of the mapping table 32 from the non-volatile memory 20 to the DRAM 30. Then, the control circuit 10 rebuilds the mapping table based on the updated version of the mapping table 32. Since the updated version of the mapping table 32 has less different with the correct mapping table, that is the latest mapping table 32 in the DRAM 30, only a small portion of the updated version of the mapping table 32 needs to be modified, and the time period of rebuilding the mapping table 32 is effectively reduced.

From the above descriptions, when the solid state storage device 100 is powered on after abnormally power interrupted, the mapping table management method of the first embodiment is capable of quickly rebuilding the mapping table 32 and rendering the normal operation of the solid state storage device 100.

However, the mapping table management method of the first embodiment still has some problems. For example, if the write data is continuously stored from the host 150 to the solid state storage device 100, the write performance of the solid state storage device 100 is deteriorated. The reason will be described as follows.

Generally, the size of the mapping table 32 is related to the total capacity of the non-volatile memory 20. In case that the total capacity of the non-volatile memory 20 is larger, the size of the mapping table 32 is larger.

While the host 150 continuously stores a great amount of write data into the solid state storage device 100, the control circuit 10 has to continuously store the write data into the non-volatile memory 20 according to the write command from the host 150. Whenever the total data amount reaches the integral multiple of the predetermined data amount, the control circuit 10 temporarily stops storing the write data into the non-volatile memory 20 in order to store the entire of the mapping table 32 from the DRAM 30 to the non-volatile memory 20.

After the entire of the mapping table 32 from the DRAM 30 is stored into the non-volatile memory 20, the control circuit 10 continuously stores the write data into the non-volatile memory 20.

As mentioned above, while the host 150 continuously stores a great amount of write data into the solid state storage device 100, the time period of storing the write data and the mapping table 32 is lengthy. That is, after the control circuit 10 stores the predetermined data amount of the write data, the control circuit 10 temporarily stops storing the write data in order to store the entire of the mapping table 32 into the non-volatile memory 20. After the control circuit 10 stores another predetermined data amount of the write data, the control circuit 10 temporarily stops storing the write data in order to store the entire of the mapping table 32 into the non-volatile memory 20. The above procedures are repeatedly done.

Obviously, in case that the time period of storing the write data and the mapping table 32 is longer, the write performance of the solid state storage device 100 is worse. In case that the total capacity of the non-volatile memory 20 is larger, the size of the mapping table 32 is larger and the write performance of the solid state storage device 100 is worse.

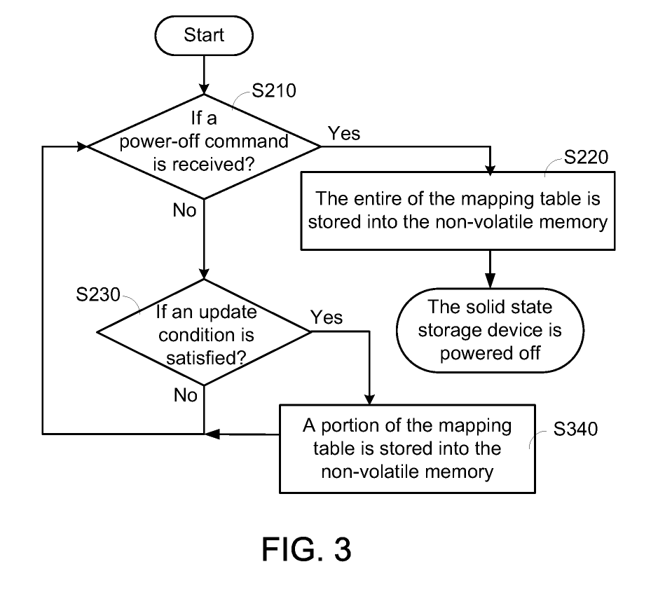

FIG. 3 is a flowchart illustrating a mapping table management method for a solid state storage device according to a second embodiment of the present invention. The mapping table management method is applied to a solid state storage device. The architecture of the solid state storage device is similar to that of FIG. 1, and is not redundantly described herein. In comparison with the first embodiment, the mapping table management method of this embodiment further comprises a step S340 in replace of the step S240. The other steps of the mapping table management method of this embodiment are similar to those of the first embodiment, and are not redundantly described herein.

If the control circuit 10 judges that the update condition is satisfied in the step S230, the control circuit 10 stores a portion of the mapping table 32 from the DRAM 30 to the non-volatile memory 20 (Step S340).

In this embodiment, the mapping table 32 is divided into M portions by the control circuit 10. If the control circuit 10 judges that the update condition is satisfied, the control circuit 10 only stores the content of one of the M portions of the mapping table 32 to the non-volatile memory 20. Consequently, the storing time is reduced.

For example, the predetermined data amount defined by the control circuit 10 is 10 Mbyte, and the mapping table 32 is divided into M portions by the control circuit 10. The control circuit 10 continuously calculates the total data amount of the write data that are stored in the non-volatile memory 20. If the control circuit 10 judges that the update condition is satisfied, the control circuit 10 stores the content of first portion of the mapping table 32 into the non-volatile memory 20.

Similarly, if the control circuit 10 judges that the update condition is satisfied again, the control circuit 10 stores the content of second portion of the mapping table 32 into the non-volatile memory 20. The rest may be deduced by analogy. Until the control circuit 10 stores the content of M-th portion of the mapping table 32 into the non-volatile memory 20 at the M-th time, it means that the control circuit 10 has stored the entire of the mapping table 32 to the non-volatile memory 20.

Then, the control circuit 10 performs storing operation at the (M+1)-th time. Meanwhile, the control circuit 10 stores the content of first portion of the mapping table 32 into the non-volatile memory 20 again. The rest may be deduced by analogy. In other words, whenever the control circuit 10 judges that the update condition is satisfied, the contents of the M portions of the mapping table 32 are sequentially and circularly stored from the DRAM 30 to the non-volatile memory 20 by the control circuit 10.

When the solid state storage device 100 is in the normal working state, the mapping table 32 stored in the DRAM 30 is continuously updated. That is, the updated mapping table 32 stored in the DRAM 30 is continuously stored into the non-volatile memory 20. Under this circumstance, if the electric power supplied to the solid state storage device 100 is abnormally interrupted, the mapping table stored in the non-volatile memory 20 has been updated and has less different with the latest mapping table 32 in the DRAM 30. When the solid state storage device 100 is powered on again, the time period of rebuilding the mapping table 32 is effectively reduced since the updated version of the mapping table 32 has less different with the correct mapping table, that is the latest mapping table 32 in the DRAM 30.

Moreover, since the mapping table 32 is divided into M portions by the control circuit 10, the time period of storing the content of one portion of the mapping table 32 is shorter. By using the mapping table management method of the second embodiment, the write performance of the solid state storage device 100 is enhanced.

In the above embodiments, the update condition is satisfied when the total data amount of the write data reaches the integral multiple of the predetermined data amount. It is noted that numerous modifications and alterations may be made while retaining the teachings of the invention. For example, in another embodiment, the control circuit calculates a total time period of storing the write data into the non-volatile memory. If the total time period reaches an integral multiple of a predetermined time period, the control circuit judges that the update condition is satisfied. Under this circumstance, the control circuit stores the updated mapping table to the non-volatile memory 20.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mapping table management method for a solid state storage device, the solid state storage device comprising a control circuit, a dynamic random access memory and a non-volatile memory, the mapping table management method comprising steps of:
the control circuit storing a write data into the non-volatile memory and updating a mapping table in the dynamic random access memory when the control circuit receives a write command;
if the control circuit receives a power-off command, the control circuit storing an entire of the mapping table from the dynamic random access memory to the non-volatile memory; and
if the control circuit judges that an update condition is satisfied, the control circuit storing a portion of the mapping table from the dynamic random access memory to the non-volatile memory.

2. The mapping table management method as claimed in claim 1, wherein the mapping table is a logical-to-physical address mapping table.

3. The mapping table management method as claimed in claim 1, further comprising steps of:
the control circuit calculating a total data amount of the write data that has been stored in the non-volatile memory; and
if the total data amount reaches an integral multiple of a predetermined data amount, the control circuit judges that the update condition is satisfied.

4. The mapping table management method as claimed in claim 1, further comprising steps of:
the control circuit calculating a total time period of storing the write data into the non-volatile memory; and
if the total time period reaches an integral multiple of a predetermined time period, the control circuit judges that the update condition is satisfied.

5. The mapping table management method as claimed in claim 1, wherein the mapping table is divided into M portions, wherein if the control circuit judges that the update condition is satisfied, a content of one of the M portions of the mapping table is stored from the dynamic random access memory to the non-volatile memory by the control circuit.

6. The mapping table management method as claimed in claim 1, wherein whenever the control circuit judges that the update condition is satisfied, contents of the M portions of the mapping table are sequentially and circularly stored from the dynamic random access memory to the non-volatile memory by the control circuit.
